(19) United States
(12) Patent Application Publication
(10) Pub. No.: US 2006/0017337 A1
(43) Pub. Date: Jan. 26, 2006

(54) Rectifier with extended stator lead connector used for charging system alternator

(75) Inventors: Gregory R. Smith, Schwenksville, PA (US); Thomas L. Haring, Birbsboro, PA (US); Raymond D. Smith III, Orlando, FL (US)

Correspondence Address: RICHARD K. WARTHER;ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(73) Assignee: WETHERILL ASSOCIATES, INC., Royersford, PA (US)

(21) Appl. No.: 10/894,656

(22) Filed: Jul. 20, 2004

(51) Int. Cl. H02K 11/00; H02K 11/04

(52) U.S. Cl. 310/68 D; 310/71

(57) ABSTRACT

A rectifier for a 3G, 6G series alternator includes circular configured negative heat sink and an arcuate configured positive heat sink secured to the negative heart sink and separated by an insulator. A plurality of negative and positive diodes is received at each of the respective negative and positive heat sinks. A terminal assembly interconnects negative and positive diodes, and includes extended stator lead connectors that connect to the stator leads of the alternator.

### FIELD OF THE INVENTION

The present invention relates to the field of alternators, and more particularly, this invention relates to rectifier assemblies having positive and negative heat sinks, respective positive and negative diodes for rectifying current, and stator leads that connect to stator lead connectors of a terminal assembly.

### BACKGROUND OF THE INVENTION

A third or sixth generation (3G, 6G) series alternator as used on Ford Motor Company and other vehicles is an advancement over second generation (2G) and similar charging system alternators that produce less amperage at comparable RPM operation. 3G, 6G and similar series alternators are offered in small applications ranging from about 75-95 ampere output to versions that have as high as 130, 160 and even about 200 amperage output using sophisticated internal components and different alternator front housing member configurations. 3G, 6G alternators are used on buses, boats, passenger cars, and trucks. Because these higher-amperage rated alternators are limited in their design to the amount of space they occupy, the alternator housing has been designed to include an increased capacity rectifier assembly with advanced diodes, a high capacity rotor winding and stator winding, and other advanced components. The 3G, 6G alternators are designed using this limited space for these advanced component parts.

Because of the high heat generated in the rectifier assembly during vehicular operation, the rectifier assembly in a 3G, 6G series alternator has a large, circular configured negative heat sink formed from a casting that is later machined to its desired tolerances. The negative heat sink typically includes an outer circumferential edge with openings forming air vents or slots. The negative heat sink is situated between the rear and front housing members forming the alternator housing. An arcuate configured positive heat sink is mounted on the negative heat sink and separated by an insulator, such as a gasket. A terminal assembly is mounted over the positive heat sink and secured to the negative and positive heat sinks. The terminal assembly typically is formed as an arcuate configured top plate member with supports for mounting the plate in a spaced relation to the positive heat sink. In the prior art original equipment manufactured (OEM) rectifier assembly, stator lead connectors are substantially flush in slots within the terminal assembly.

During assembly of a 3G, 6G and similar series alternator, the stator leads, i.e., the stator wires extending from the stator winding assembly, are connected to the substantially flush stator lead connectors positioned in the slots on the terminal assembly. The entire rectifier assembly is typically run across a wire solder machine, which solders the stator leads, i.e., stator wire ends to the substantially flush stator lead connectors.

In an alternator rebuild or tear-down operation, the stator leads, i.e., the stator wire ends connected to the stator lead connectors, are cut short and sometimes flush, leaving little remaining of the stator lead to be connected and soldered onto any stator lead connectors of a similar replacement rectifier assembly having a terminal assembly with substantially flush stator lead connectors. As a result, a rebuilder must pull and stretch the stator wires and extend any stator leads to reach the respective stator lead connectors on the new rectifier assembly, resulting in a poor connection of the stator leads to the terminal assembly. These shortened stator leads also create difficulty when salvaging the stator assembly during the tear-down process. Thus, any profit in an alternator rebuild or tear-down is decreased because of the increased time necessary for rebuilding the alternator. An even greater drawback is the possibility that the stator winding assembly must be replaced because the stator winding assembly had its stator leads cut too short. This entire rebuild process causes expensive material components to be lost in the tear-down or rebuild process, increasing the cost of a tear-down and rebuild.

### SUMMARY OF THE INVENTION

It is therefore an object of the present invention to overcome the disadvantages associated with rebuilding a 3G, 6G series alternator as explained above.

It is yet another object of the present invention to provide a rectifier assembly for a 3G, 6G series alternator that can be readily adapted to a rebuild or tear-down.

The present invention advantageously uses a rectifier assembly that includes extended stator lead connectors extending from the terminal assembly, instead of substantially flush stator lead connectors used in prior art, original equipment manufactured rectifier assemblies of alternators. This use of the extended stator lead connectors enhances production and reduces costs of the 3G, 6G series alternator rebuild or tear-down. As the stator leads are cut and shortened during the tear-down, the shortened stator leads do not have to be pulled excessively to provide an adequate connection between the shortened stator leads and extended stator terminal connectors on rectifier assembly. The shortened stator leads can be more easily crimped onto the stator lead connectors and subsequently soldered or welded.

In one aspect of the present invention, the extended stator lead connectors are formed as clasps that have clasp members that can be squeezed or bent together onto a stator lead and later soldered or welded.

### BRIEF DESCRIPTION OF THE DRAWINGS

Other objects, features and advantages of the present invention will become apparent from the detailed description of the invention which follows, when considered in light of the accompanying drawings in which:

FIG. 1 is a perspective view of a 3G, 6G series alternator looking toward the alternator rear housing member and showing the different connections from terminals on the rear housing member to various automobile components illustrated as block components.

FIG. 2 is a plan view of a prior art rectifier assembly used for a 3G, 6G series alternator and showing substantially flush stator lead connectors formed in slots on the terminal assembly.

FIG. 3 is an enlarged, perspective view of the prior art stator lead connector formed substantially flush in slots on the terminal assembly.

FIG. 4 is a perspective view of the rectifier assembly of the present invention used for 3G, 6G series alternators and showing the extended stator lead connectors.

FIG. 5 is another perspective view of the rectifier assembly of the present invention looking in the direction of arrow 5 of FIG. 4, and showing the negative and positive heat sinks and the terminal assembly.

FIG. 6 is perspective view of the rectifier assembly of the present invention looking in the direction of arrow 6 of FIG. 5 and showing greater details of a portion of the negative heat sink, positive heat sink, press fitted diodes and terminal assembly.

FIG. 7 is an enlarged, side elevation view of the rectifier assembly of the present invention and showing in greater detail the extended stator lead connectors.

FIG. 8 is a rear plan view of the rectifier assembly looking into negative heat sink and showing the bottom portion of the press fitted diodes.

FIG. 9 is an enlarged, perspective view of an extended stator lead connector of the present invention and showing its position relative to the negative and positive heat sinks.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

The present invention advantageously enhances the rebuild or tear-down process of 3G, 6G and similar series alternators, which include an original equipment manufactured (OEM) rectifier assembly having stator lead connectors formed substantially flush in slots of the terminal assembly. During the rebuild or tear-down process, stator leads are cut from the terminal assembly, shortening the overall length of the stator leads. The prior art rectifier assembly is removed, and replaced with the rectifier assembly of the present invention, having extended stator lead connectors that extend downward from the edge of the top plate member of the terminal assembly toward the heat sinks. The present invention enhances rebuild with the crimping and soldering/welding of these shortened stator leads, i.e., the stator wire ends onto the extended stator leads. The present invention enables a more efficient tear-down and rebuild of the alternator. A tighter and more reliable connection is made to the extended stator lead connectors of the present invention than would be possible with the use of the prior art, OEM rectifier assembly having the substantially flush stator lead connectors positioned in slots formed on the edge of the terminal assembly.

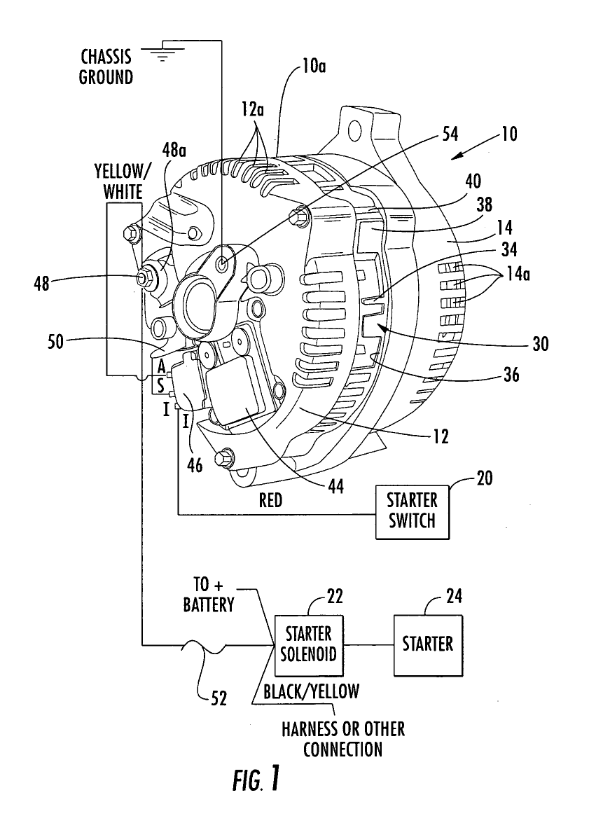

For purposes of explanation and understanding of the present invention, a short description of a 3G, 6G series alternator is described with reference to FIG. 1, followed by a more detailed description of the prior art rectifier assembly used as OEM equipment. There then follows the description of the rectifier assembly of the present invention using the extended stator lead connectors.

For purposes of this description, the terms for 3G series and 6G series alternators can be used interchangeably because the rectifiers used in 3G and 6G series alternators are similar with only minor differences. Both use bridge rectifiers as a rectifier assembly supported by an alternator body and connected to stator leads of the stator windings for receiving and rectifying the electrical output from the stator windings. The rectifier assembly includes a circular configured negative heat sink and arcuate configured positive heat sink mounted on a portion of the negative heat sink, including an insulator electrically separating the negative and positive heat sinks. A plurality of diodes are secured to positive and negative heat sinks. A terminal assembly, or lead frame as it is often referred, is secured to the heat sinks over its positive heat sink and interconnecting respective diodes in a diode rectifier configuration. The terminal assembly includes externded stator lead connectors that extend from the terminal assembly and secure stator leads. This rectifier assembly is positioned between the front and rear housing members.

Throughout this description, the term 3G, 6G or similar series alternator or any combination will refer to the entire series alternators.

Motorcraft/Ford alternators, known as 3G (3rd generation) and 6G (6th generation), are very similar in design and construction, one to the other, to include the component makeup of the bridge rectifier assembly portion of the alternator assembly. The 3G series alternator was introduced in model year 1989 for applications to included various Ford, Lincoln and Mercury models and had continued use through model year 2002.

Two physical sizes of alternators make up the 3G series and are generally identified by the approximate outside diameter of the stator and, or machined castings. 133 mm OD typically represents the smaller frame 3G series with standard rated outputs of 75 Amps or 95 Amps. 146 mm OD typically represents the larger frame 3G series with standard rated outputs of 115 Amps or 130 Amps. The larger 146 mm OD 3G series is occasionally customized by professional automotive electrical mechanics, through the modification of the stator, or stator and rotor combination, and the upgrade of the bridge rectifier assembly, through the replacement of the standard rated diodes with more robust diodes, to provide outputs up to and sometimes exceeding 200 Amps. The 3G series rectifier lead frame concept, having drop-down, i.e., extended stator-lead attachment terminals of the present invention, would be common to both OD sizes and all outputs of 3G series alternators.

The Motorcraft Ford 6G series alternator was introduced in model year 1998 for applications to include various Ford, Lincoln, and Mercury models and continues to be used through the current model year. Two physical sizes of alternators make up the 6G series and are generally identified by the approximate outside diameter of the stator and, or machined castings. 136 mm OD typically represents the smaller frame 6G series with standard rated output of 105 Amps or 110 Amps. 149 mm OD typically represents-the larger frame 6G series with standard rated output of 135 Amps.

The larger 149 mm OD 6G series is occasionally customized by professional automotive electrical mechanics, through the modification of the stator, or stator and rotor combination, and the upgrade of the bridge rectifier assembly, through the replacement of the standard rated diodes with more robust diodes, to provide outputs up to and sometimes exceeding 200 Amps. The 6G rectifier lead frame, having drop-down stator-lead attachment terminals of the present invention, would be common to both OD sizes and all outputs of 6G alternators. It would also be applicable to all 6G rectifier assemblies, regardless of the metal circuitry design that is molded within the plastic of the lead-frame assembly (not visibly noticeable), required to accommodate either a 6-diode or 8-diode design assembly.

FIG. 1 is a perspective view of a 3G, 6G series alternator 10 looking in the direction of the alternator rear housing member 12 and showing various connections from terminals on the rear housing member to different automobile components shown in block format, including a starter switch 20, starter solenoid 21 and starter 24.

This alternator 10 has a housing 10a that is typically formed from cast and machined parts, including an alternator front housing member 14 and alternator rear housing member 12, both which are cast and later machined to manufacturer tolerances. Both alternator front and rear housings members 12, 14 include appropriate air slots or vents 12a, 14a formed in the circumferentially extending sides to allow sufficient cooling of all electrical components supported within the alternator housing 10a. The alternator housing 10a formed by the front and rear housing members 12, 14 includes support bearings (not shown) using high temperature grease formulations to support a rotor winding assembly having welded and epoxied leads for reliability and high tolerance at a low RPM output. The rotor winding assembly includes an output shaft that extends through the alternator front housing member 14 and mounts a drive pulley formed from precision machined steel pulleys. A stator winding assembly is mounted within the alternator body and includes laminations, as known to those skilled in the art.

Also illustrated between the front and rear housing members is a rectifier assembly 30, also termed a bridge or diode rectifier, which includes a circular configured negative heat sink 32, a circumferentially extending outer surface 34 with open areas forming air vents or slots 36, and fastener protrusions 38 that receive fasteners, for example, the illustrated bolt 40 that secures the alternator rear housing member 12 to the alternator front housing member 14, as shown in FIG. 1.

A voltage regulator 44 is mounted on the rear surface of the rear housing member 12. A socket 46 is an ASI terminal socket. The socket 46 receives wires that correspond to the alternator or “A” terminal and has a connection wire that extends from the “A” terminal to the battery or B+ terminal 48. The “S” or stator terminal-has a connection wire that extends from the “S” terminal to a single wire stator connector 50 positioned on the rear housing member 12. The “I” or ignition terminal has a connection wire that extends from the “I” terminal to the starter switch 20, which is “hot” in the run/start position. The connection wires can be color coded, for example with the “I” ignition connection wire as a red colored wire, the “A” or alternator connection wire as a yellow/white wire, and the “S” or stator connection wire as a white/black wire.

The B+ terminal 48 typically includes a red grommet 48 and connects by six-gauge wire to the starter solenoid 22. This six-gauge wire is usually capable of handling up to 130 amps (and possibly up to 200 amps depending on the design and application of the alternator). A megafuse 52, such as a 175 amp or greater fuse, is positioned in-line for protection. The starter solenoid 22 includes a wire that extends to the positive terminal in a battery and another black/yellow wire that extends to a harness or other connection. The starter solenoid 22 connects to the starter 24, as known to those skilled in the art. A chassis ground connection 54 is also included on the rear housing member 12, as known to those skilled in the art.

The 3G, 6G series alternator can include a smaller amperage version, from as little as 75-95 amperage output, to a larger amperage version having 130, 160 and as much as 200 amperage output. The illustrated 3G, 6G series alternator of FIG. 1 is an example of an IR/IF 130 ampere, 12 volt alternator, shown without a pulley. This particular example alternator can be used on many 1999-93 Ford and Mercury Sable 3.0 liter cars and 1998-95 Ford Windstar 3.0 liter cars. Naturally, the entire 3G, 6G and similar series line of alternators encompasses its use on many different types of vehicles. The alternator shown in FIG. 1 is only one representative example.

The voltage regulator 44 is typically a high ampere MOSFET field effect transistor voltage regulator commonly known to those skilled in the art. This alternator 10 typically includes high-temperature, class H windings and a six groove pulley. In an engine idle speed of about 750 rpm, a 3G, 6G series alternator can generate over twice as much amperage than a stock, second generation (2G) series alternator. For example, one common type of 3G, 6G series alternator can perform from idle to about 3,000 rpms (the typical RPM point for a maximum alternator output) and produce about 75 amperes at 800 rpm, about 13.77 volts at idle, and a maximum current of about 149 amperes at about 3,000 rpm. This could be used, for example, on a 5-liter Mustang. A 2G series alternator on a 5-liter Mustang would produce about 30 amperes at 800 rpm and about 11.78 volts, and only about 80 amperes at about 3,000 rpms.

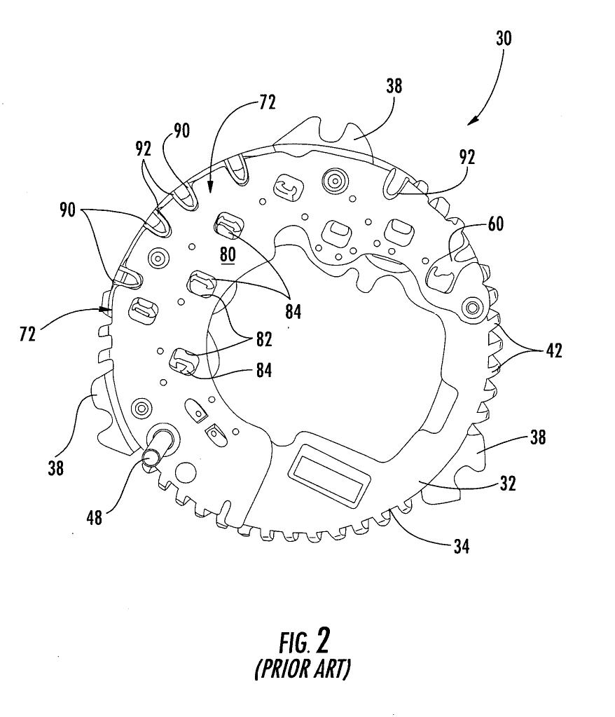

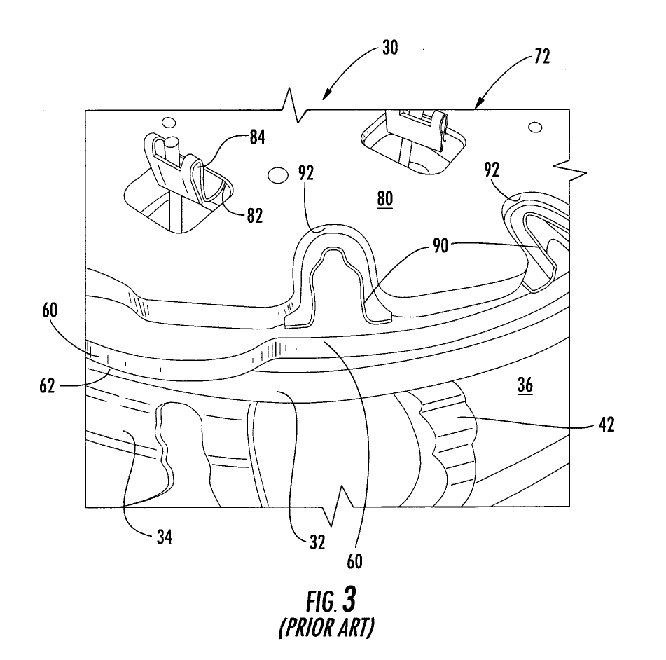

FIGS. 2 and 3 show a prior art rectifier assembly 30 for a 3G, 6G series alternator. The rectifier assembly 60 is also termed a bridge rectifier or diode rectifier. The rectifier assembly 30 includes the circular configured negative heat sink 32 that is typically formed from a casting with the air vents or slots 36 and fastener protrusions 38 that receive fasteners, such as the bolts 40 as explained with reference to FIG. 1. A circumferentially extending ridge 42 on the outer surface 34 forms a lip that seats within a similarly designed receiving area on the alternator rear housing member 12. The alternator 10 has the rectifier assembly 30 positioned between the rear and front housing members 12, 14.

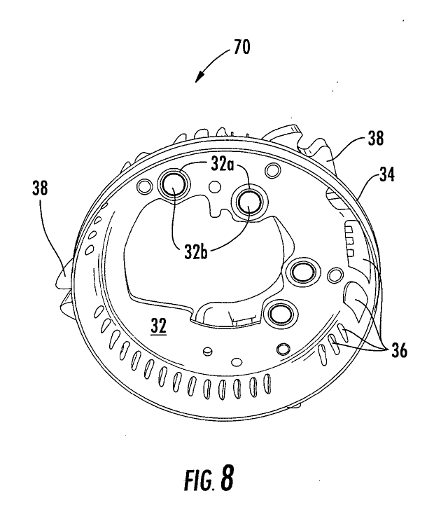

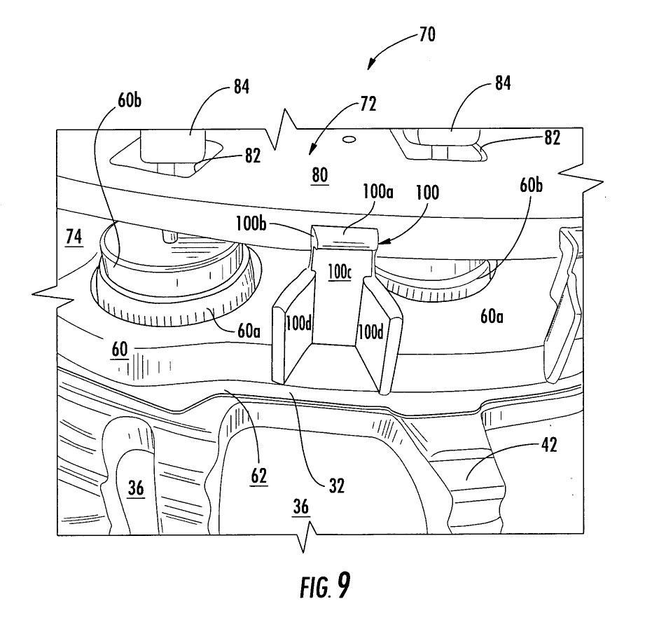

An arcuate configured positive heat sink 60 is mounted on the negative heat sink 32 but separated from the negative heat sink by an insulator gasket 62. Both negative and positive heat sinks 32, 60 include diode openings 32a, 60a in which respective negative and positive diodes 32b, 60b (FIGS. 8 and 9) are press fitted within the openings. In the illustrated example, each heat sink 32, 60 receives four respective negative or positive diodes 32b, 60b, connected in either a preferred delta or wye connection depending on the design considerations.

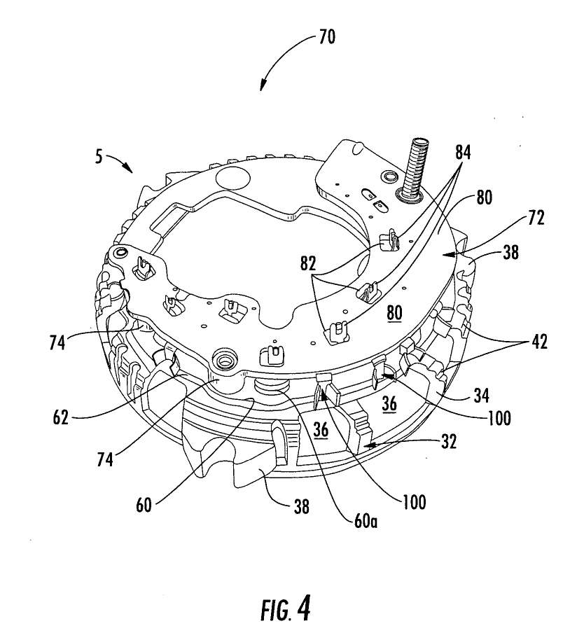

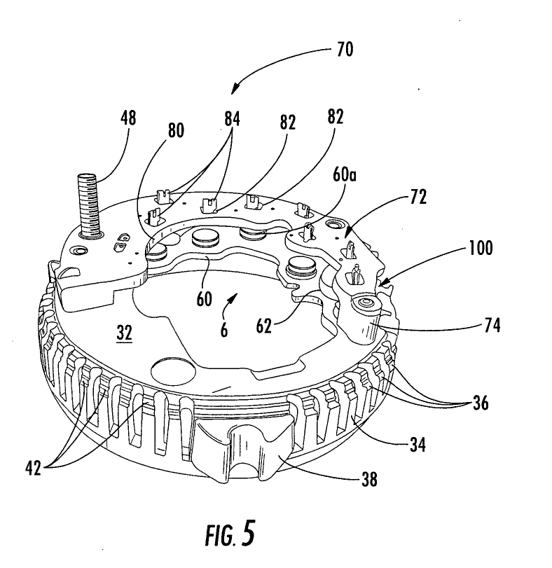

FIGS. 4-9 show the rectifier assembly 70 of the present invention. Because many of the component parts of the prior art rectifier assembly 30 shown in FIGS. 2-3 are the same as those used on the rectifier assembly 70 of the present invention as shown in FIGS. 4-9, common reference numerals are used in many portions of the description to avoid confusion.

FIG. 8 shows the negative heat sink 32 that has four negative diodes 32b press fitted within diode openings 32a formed within the negative heat sink. Four positive diodes 60b are similarly press fitted in diode openings 60a of the positive heat sink 60. An example of the structure and manufacturing of a diode that can be used with the present invention is disclosed in commonly assigned U.S. Pat. No. 6,642,078, the disclosure which is hereby incorporated by reference in its entirety. The diodes, also referred to as diode assemblies, include diode cups, semiconductor diode dies, and diode leads fitted therein. The diode subassemblies can be reflow soldered, allowing the semiconductor diode die and diode lead to be reflow soldered within a diode cup. A lead loader has a removable lead holder that holds diode leads therein, which can be positioned over a diode boat, such that the diode leads can be aligned with respective diode cups. The lead holder can be slid from the lead loader so that the diode leads falls into the center cups, which also have the semiconductor die positioned therein. The diode boat can be inserted within a furnace for reflow soldering.

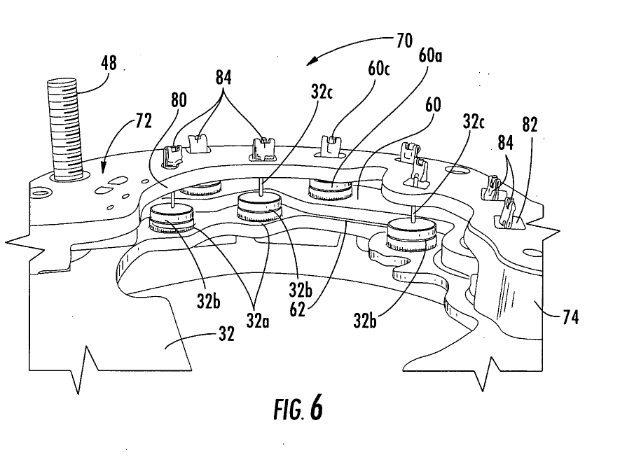

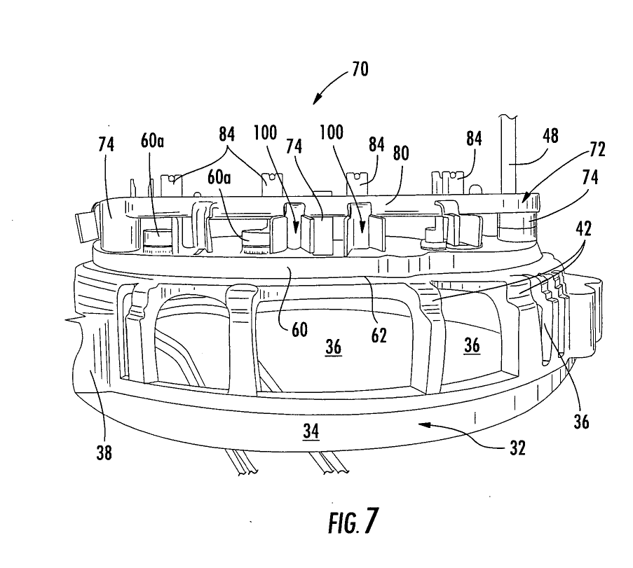

A terminal assembly 72 is mounted over the positive heat sink 60 and partially onto the negative heat sink 32. As shown in FIGS. 6 and 7, the terminal assembly 72 includes support members 74 that engage the negative and positive heat sinks 32, 60. Rivets 76 or similar fasteners secure together the terminal assembly 72, negative heat sink 32 and positive heat sink 60 that is positioned between the terminal assembly 72 and negative heat sink 32. The terminal assembly 72 includes an arcuate and substantially planar top surface, formed as plate member 80 having diode lead openings 82, illustrated as rectangular openings in this non-limiting example, which receive diode leads 32c, 60c to be secured by diode terminals 84 in the openings 82. The diode leads, 32c, 60c are cut and soldered to the diode terminals 84 (FIG. 6).

As shown in the prior art rectifier assembly 30 in FIGS. 2 and 3, prior art stator lead connectors 90 are received in slots 92 formed at the outer edge of the terminal assembly and formed substantially flush with the plate member 80. These substantially flush, prior art stator lead connectors 90 receive stator leads, i.e., the stator wire ends, which are soldered to the connectors as the entire assembly is passed across a wire soldering machine. During this process, the rectifier assembly is typically connected to the rear housing member of the alternator. As also illustrated, the battery or B+ terminal 48 extends from the positive heat sink 60 to which it is mounted and through the terminal assembly 72.

The terminal assembly 72 is formed by injection molding techniques, although other construction techniques can be used. Injection molding is advantageous because in this process, plastic can be injected into a mold containing the various terminals and metal contacts that ultimately form the diode terminals and stator lead connectors and form with high accuracy the terminal assembly as illustrated.

The rectifier assembly 70 of the present invention includes extended stator lead connectors 100 that extend downward toward the negative and positive heat sinks 32, 60. These extended stator lead connectors 100 of the present invention have a shortened section 100a that extends outward from the side of the top plate member 80. The cut-outs or slots 92 as used in the prior art rectifier assembly 30 shown in FIGS. 2 and 3 are not required for the present invention. A 90 degree bend 100b on the stator lead connector is followed by a clasp 100c, formed by two winged, clasp members 100d that extend outward at an obtuse angle (FIG. 9).

The present invention is advantageous in a rebuild or tear-down in which the stator leads, i.e., stator wire ends are cut and shortened. Once the stator wires are cut, the stator leads are shortened and if a prior art replacement rectifier assembly used, it is very difficult to secure the shortened stator leads onto the substantially flush stator lead connectors.

With the use of the stator lead connectors 100 of the present invention, however, a stator lead (i.e., stator wire end) may be cut too short in the tear-down. The shortened stator leads can be pulled into a position adjacent the clasp 100c, which is then squeezed at the clasp members 100d. The shortened stator lead is later soldered or welded at the clasp members 100d. Thus, the tear-down and rebuilding process is enhanced with the present invention. Also, the clasp members 100d are located farther away from the injection molded plastic forming the top plate member as compared to prior art, OEM rectifier assemblies, and thus, during a solder or welding process, the top plate member will not be heated as much as compared to soldering a prior art substantially flush stator lead connector, which is located right as the top plate member 80. Excess heat generated at the top plate member 80 of the terminal assembly would damage the entire terminal assembly and possibly heat the diode leads and damage the diodes.

Also, the present invention can be used in original equipment manufactured (OEM) 3G, 6G series alternators direct from a factory. Removal of the stator leads or stator wire ends during rebuild or tear-down can be enhanced with the use of the present invention. The clasps 100c can be heated to melt any solder, and the clasp members 100d folded-out and the stator leads removed without having to cut them. This is also an advantage over the heavily soldered substantially flush prior art stator lead connectors in which the plastic terminal assembly could be damaged during a heating process to remove the stator leads, or during a rebuild soldering or welding process.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An alternator comprising:
an alternator body;
a rotor coil mounted for rotation within the alternator body;
stator windings supported within the alternator body for producing an electrical output as the rotor coil is rotated; and
a rectifier assembly supported by the alternator body and connected to stator leads of the stator windings for receiving and rectifying the electrical output from the stator windings, said rectifier comprising:
a circular configured negative heat sink and arcuate configured positive heat sink mounted on a portion of the negative heat sink, including an insulator electrically separating the negative and positive heat sinks;
a plurality of diodes secured to positive and negative heat sinks; and
a terminal assembly secured to said heat sinks over the positive heat sink and opposite the negative heat sink and interconnecting respective diodes in a diode rectifier configuration, said terminal assembly including extended stator lead connectors that extend from the terminal assembly and secure stator leads.

2. An alternator according to claim 1, wherein said alternator body includes a front housing member, and a rear housing member wherein said rectifier assembly is positioned between said front and rear housing members.

3. An alternator according to claim 1, wherein said extended stator lead connectors each comprises a clasp having clasp members that receive a stator lead.

4. An alternator according to claim 3, wherein said clasp members extend downward from said terminal assembly.

5. An alternator according to claim 3, wherein said clasp members extend outward at an obtuse angle.

6. An alternator according to claim 3, wherein said clasp members are formed to be bent around a stator lead.

7. An alternator according to claim 1, wherein said terminal assembly comprises an arcuate configured top plate member secured over said arcuate configured positive heat sink.

8. An alternator according to claim 1, wherein said terminal assembly includes diode terminals interconnected to said diodes.

9. An alternator according to claim 1, wherein said diodes each comprise press fitted diodes within said negative and positive heat sinks.

10. A rectifier assembly adapted for use in an alternator and to be connected to stator leads of stator windings for receiving and rectifying the electrical output from the stator windings, said rectifier comprising:
a circular configured negative heat sink;
an arcuate configured positive heat sink mounted on a portion of the negative heat sink;
an insulator electrically separating the negative and positive heat sinks;
a plurality of diodes secured to positive and negative heat sinks; and
a terminal assembly secured to said heat sinks over the positive heat sink and opposite the negative heat sink and interconnecting respective diodes in a diode rectifier configuration, said terminal assembly including extended stator lead connectors that extend from the terminal assembly and adapted to connect to stator leads.

11. A rectifier assembly according to claim 10, wherein said rectifier assembly is configured to engage between a front housing member and a rear housing member of an alternator body.

12. A rectifier assembly according to claim 10, wherein said extended stator lead connectors each comprises a clasp having clasp members that receive a stator lead.

13. A rectifier assembly according to claim 12, wherein said clasp members extend downward from said terminal assembly.

14. A rectifier assembly according to claim 13, wherein said clasp members extend outward at an obtuse angle.

15. A rectifier assembly according to claim 13, wherein said clasp members are formed to be bent around a stator lead.

16. A rectifier assembly according to claim 10, wherein said terminal assembly comprises an arcuate configured top plate member.

17. A rectifier assembly according to claim 10, wherein said terminal assembly includes diode terminals connected to said diodes.

18. A rectifier assembly according to claim 10, wherein diodes each comprise press fitted diodes.

19. A method of rebuilding an alternator, which comprises:
cutting the stator leads connected to stator lead connectors of a rectifier assembly supported by an alternator body of an alternator such that the stator leads are shorter than the length in an original equipment manufactured (OEM) condition;
replacing the rectifier assembly with a rectifier assembly that includes extended stator lead connectors that extend from a terminal assembly of the rectifier assembly; and
securing the stator leads to the extended stator lead connectors.

20. A method according to claim 19, which comprises bending clasp members over a stator lead.

21. A method according to claim 19, which comprises soldering a stator lead to an extended stator lead connector.
